(19) United States
(12) Patent Application Publication
(10) Pub. No.: US 2005/0211091 A1
(43) Pub. Date: Sep. 29, 2005

(54) Thermally programmable gas storage and release

(76) Inventors: Igor Moudrakovski, Ottawa (CA); Gary Enright, Ottawa (CA); Kontantin Udachin, Chelsea (CA); John Ripmeester, Ottawa (CA)

Correspondence Address: George A. Seaby;Seaby & Associates, 603 - 250 City Centre Avenue, Ottawa, ON, K1R 6K7, CA

(21) Appl. No.: 11/088,812

(22) Filed: Mar. 25, 2005

Related U.S. Application Data
(60) Provisional application No. 60/556,897, filed on Mar. 29, 2004.

(51) Int. Cl. B01D 53/02

(52) U.S. Cl. 95/139

(57) ABSTRACT

The P2₁/n crystal form of p-tert-butylcalix(4)arene (tBC) can be used to adsorb a gas or to selectively adsorb a component from a gas mixture, e.g. carbon dioxide from a mixture of hydrocarbons and CO₂. The adsorbed gas can be desorbed by heating the tBC/gas combination.

This application claims the benefit of U.S. Provisional Application No. 60/556,897, filed Mar. 29, 2004.

### BACKGROUND OF THE INVENTION

Field of the Invention

This invention relates to a method of gas storage and release, and in particular to a method of gas storage and release using a p-tert-butylcalix(4)arene (tBC) polymorph.

The synthesis of frameworks for storage, processing, and controlled release of molecular species is a much-researched topic today. Many such frameworks have been assembled via directional bonds of various strengths, for example, covalent, H-bonding and metal-coordination, yielding frameworks of varying degree of robustness [see, for example M. Eddaoudi et al, Science 2002, 295,469, K. Uemura et al, Chem-Eur. J. 2002, 3586 and T. Tanaka et al, Chem. Lett. 2002, 12, 1424]. As well, recently there has been a keen interest in frameworks that transform under some of external stimuli to take on different functions, these sometimes being referred to as smart, responsive, or third generation materials [see, for example S Kitagawa et al, Bull. Chem. Soc. Jpn 1998, 71, 1739 and D. Soldatov et al, J. Am. Chem. Soc. 1999, 121, 4179]. Few simple van der Waals solids have shown a propensity for this kind of application [see J. L. Atwood et al, Science 2002, 296, 2367], although such solids are often flexible, suggesting that there should be a dimension of response possible [see S. Kitagawa et al (supra), D. Soldatov et al (supra) and J. L. Atwood et al, Science 2002, 298, 1000]. Crystalline van der Waals solids that can change function cyclically via a relative low energy pathway clearly have the potential for some applications.

The object of the present invention is to provide a method of gas storage and release using a polymorph of tBC in which molecules can be loaded or released from single crystals of the tBC, or from polycrystalline or nanocrystalline tBC by controlling guest concentration and temperature.

Accordingly, the invention relates to a method of adsorbing a gas comprising the step of exposing the gas to the P2₁/n crystal form of p-tert-butylcalix(4)arene or to a form of p-tert-butylcalix[4]arene derived by heating the p-tert-butylcalix[4]arene to a temperature above the phase transition temperature thereof. The phase transition temperature is approximately 90° C.

### BRIEF DESCRIPTION OF DRAWINGS

The invention is described below in greater detail with reference to the accompanying drawings wherein:

FIG. 1 shows schematic drawings of the crystal structure of the P2₁/n form of tBC and the inclusion compound of the tBC with xenon;

FIG. 2 shows a graph of temperature scans for various ingredients of a gas mixture;

FIG. 3 is an isothermal run at 100° C. for the xenon compound;

FIG. 4 shows ¹²⁹Xe NMR spectra recorded under continuous flow conditions with hyperpolarized xenon at different temperatures: (a) 25°, (b) 60° C., (c) 80° C. and (d) 100° C.;

FIG. 5 is a graph of adsorption isotherms, i.e. the amount of gas adsorbed as a function of applied gas pressure for CO₂ and CH₄ at two different temperatures; and

FIGS. 6 and 7 are graphs of pressure versus time for material of the same particle size which illustrate the kinetics of the adsorption of methane on tBC.

### DETAILED DESCRIPTION OF THE INVENTION

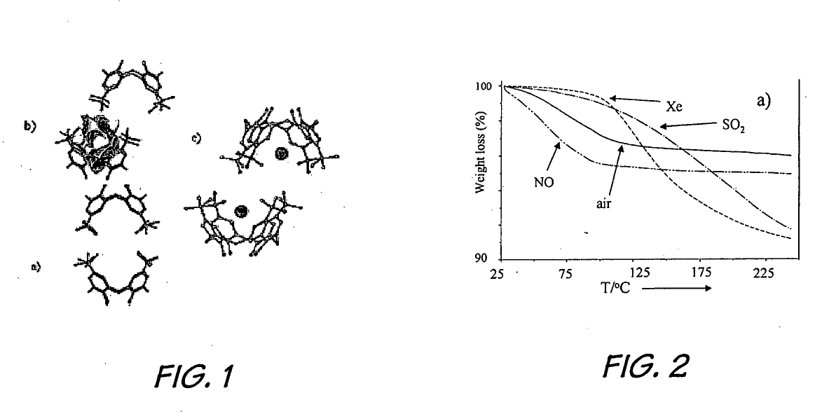

p-tert-butylcalix[4]arene (tBC) is an extremely versatile inclusion host, with several guest-directed structural motifs [see G. D. Andreetti et al, J. Chem. Common. 1979, 1005, R. Ungaro et al, J. Chem. Soc. Perkin Trans. 1985, 2, 197, E. Brouwer et al, J. Chem. Commun. 1998, 587 and K. A. Udachin et al, J. Supramol. Chem. 2001 1, 97]. By far, the most common forms are the 1:1 (P4/n) and 2:1 (P4/nnc) tetragonal crystal forms, obtained by recrystallization of the host material from solvents consisting of small guests, e.g. benzene, toluene and pentane in the first instance, and from somewhat larger guests, e.g. hexane and p-xylene in the second. Guest-free forms are obtained by heating inclusion compounds above ˜150° C., yielding either a dense, self-included form or a low-density P2₁/n form, the crystal structure of which is shown at (a) in FIG. 1, depending on the conditions [see J. L. Atwood et al, Science 2002, 298 (supra), E. B. Brouwer et al, J. Chem. Commun. 2001, 565 and E. B. Brouwer et al, J. Chem. Commun. 2003, 1416]. The low-density form in fact can be converted to the P4/n 1:1 compound by exposing the material to a guest liquid [see J. L. Atwood et al Science 2002, 298 (supra)].

Single crystals of the guest-free P2₁/n form can also be converted into a new family of 1:1 guest-host materials where the host lattice does not change; that is it remains P2₁/n. When a single crystal of the P2₁/n form is heated at temperatures between room temperature and 140° C. in a sealed tube under ˜20 atm of xenon, the Xe guest filled at least half of the cavities, the single crystal remaining intact and the crystal structure (as viewed along the a axis) of the P2₁/n-Xe product (c) in FIG. 1 remaining the same as that for the empty form, which is shown at (a) and (b) in FIG. 1, (a) being empty calixarenes as viewed along the a axis and (b) being the empty calixarenes as viewed along the c axis, the shading showing the van der Waals surface inside the cavity. These crystals were stable at room temperature for a period of at least days. Crystallographic data of the P2₁/n form of tBC and the P2₁/n-Xe compound and further experimental details (PDF) are available via the Internet at http://pubs.acs.org.

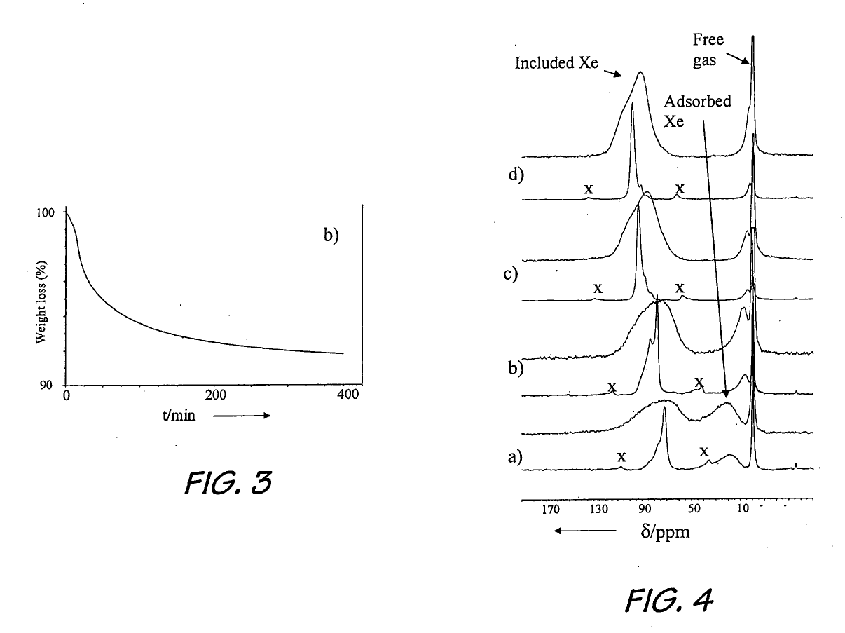

The accessibility of crystal form P2₁/n with respect to the loading and release of small guest molecules was tested for NO, air, SO₂, and Xe by sealing the gas and host material into a Pyrex tube to achieve pressures of 10-20 atm. Release of the gases as a function of temperature from the products was checked with TGA (FIG. 2) for Xe also under isothermal conditions of 100° C. (FIG. 3), the weight losses varying between 4 and 10%. The larger guests are retained quite tenaciously considering that the bulk guest materials are well above their boiling points. The isothermal plot for Xe shows that the rate of guest release becomes slower with increasing length of time, suggesting that the process is thermally activated with the interior guests traveling a longer diffusional path length than those near the surface of the particles. Xe NMR spectroscopy, using hyperpolarized xenon produced in a continuous flow system [see l. L. Moudrakovski et al Chem. Mater. 2000, 12, 1181], lends itself well as an in-situ probe of the temperature-dependent access to the guest sites in the P2₁/n form of tBC [see A. V. Nossov et al, J. Am. Chem. Soc. 2001, 123, 3563]. FIG. 4 shows a set of ¹²⁹Xe spectra for the P2₁/n form of tBC in contact with a flowing gas mixture (98% He, 1% N₂, 1% Xe) containing HP Xe (partial pressure 7 Torr) as a function of temperature under both static and spinning conditions.

The room temperature spectrum shows resonances at 0, ˜20, and 75 ppm which can be assigned to free xenon gas, Xe interacting with the outside surface, and xenon interacting with host cavities, respectively. The width and shape of the 20 ppm line suggest that considerable exchange occurs. As the temperature increases, the latter line shifts toward that of the free gas, as the rate of exchange with xenon in the free gas also increases. The isotropic low field line always shows some fine structure. This is attributed to the presence of a phase change that takes place for the empty lattice at ˜90° C. [see E. B. Brouwer et al, J. Chem. Commun. 2003 (supra)].

Loading of the host will change the transition temperature, and nonuniform loading will give a range of such transition temperatures. The largest change in the spectrum comes between 60 and 800, where the strongest isotropic component shifts from the high field to the low field side of the complex peak, so it is likely that the bulk of the sample transforms in this temperature range. At the highest temperature, the Xe powder pattern has an isotropic chemical shift of ˜105 ppm which corresponds to Xe inside the calixarene cavities. So, as the temperature is increased from room temperature to 100° C., the Xe atom locations change from a good fraction being external to the host cavities to being almost completely included in such cavities. The spectra confirm that passage in and out of the crystal by flowing xenon gas is rather difficult at room temperature and much easier at 100° C. It is also noted that the Xe powder pattern is quite different from that obtained previously for the mixed Xe/nitrobenzene calix compound, the larger chemical shift confirming that the cavity is much smaller in the P2₁/n-Xe product than in the known versions of the 1:1 compound [see E. B. Brouwer et al, J. Chem. Commun. 1997, 939]. The observation of reversible functional behavior involving the release or adsorption of guest species makes the material suitable for applications such as the release of packaged reagents (SO₂, HCl) or the controlled release of biologically active species (NO). Storage of guest molecules, including low-boiling gases, can be accomplished by loading at about room temperature under a high guest pressure, followed by storing at a suitable temperature. Controlled release can then be accomplished by thermal programming. Another application is molecular sieving, as it was noted that even at room temperature compound P2₁/n takes up components from air. It is clear that the collective weak forces in van der Waals hosts are remarkably strong in retaining highly volatile guests, yet they can be responsive to external conditions so that cavity hosts should be considered for possible applications, a role primarily considered for the many novel open channel systems recently reported. Preliminary experiments were carried out to determine whether the P2₁/n form of tBC could be used to remove certain components from gas mixtures. The experiments were performed as follows:
1) a number of gas mixtures of various proportions were prepared as shown in the table below, and their infrared spectra were recorded:
2) powdered tBC was exposed to the gas mixture, and left in contact for a number of hours (best results were obtained either when leaving the sample for a day, or, heating the sample and leaving it for a shorter period);
3) the non-adsorbed gas was removed, and its infrared spectrum taken; and

4) the gas in the tBC was removed by heating under vacuum, and its infrared spectrum was taken.

| | | | IR Band | IR Band | |
|---|---|---|---|---|---|
| | | | intensity | intensity ratio | |
| | | Proportion of | ratio | in adsorbed | Component |
| | | each gas in | before | gas | adsorbed |
| Gas1 | Gas2 | mixture | (gas1/gas2) | (gas1/gas2) | selectively |
| CO₂ | SO₂ | 1:1 | 0.22 | 0.32 | CO₂ |
| CO₂ | SO₂ | 1:1 | 0.29 | 0.36 | CO₂ |
| CO₂ | CH₄ | 1:9 | 0.27 | 0.42 | CO₂ |
| CO₂ | CH₄ | 1:9 | 0.22 | 0.38 | CO₂ |
| CO₂ | C₃H₈ | 1:1 | 0.19 | 0.36 | CO₂ |

When the band intensity ratios in the initial gas are compared with those in the desorbed gas, a change in ratio denotes that one component has been adsorbed preferentially. The results indicate that tBC is slightly selective towards carbon dioxide over sulfur dioxide, and quite strongly selective towards carbon dioxide over methane and propane.

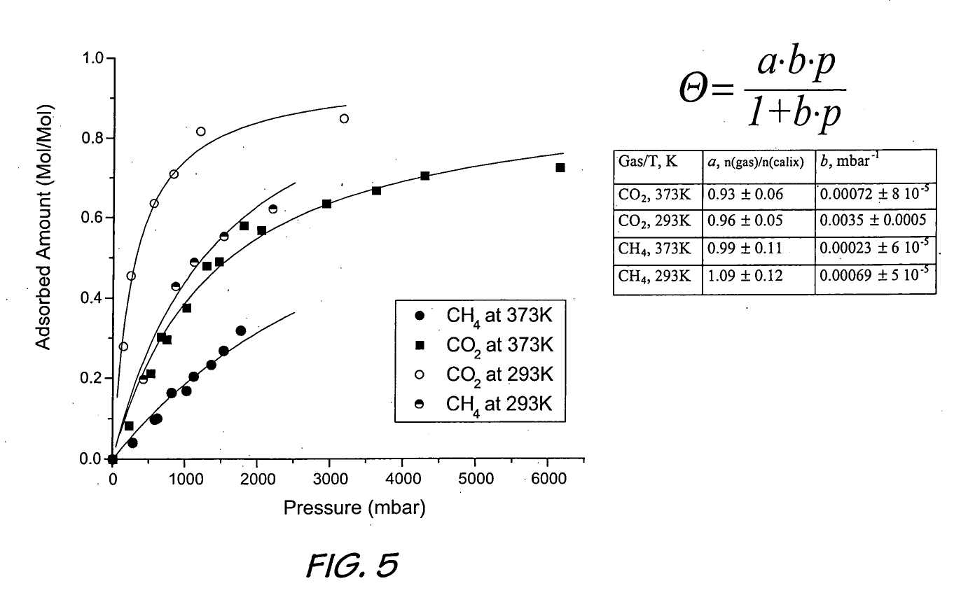

Reference is made to FIG. 5, which includes plots of the amounts of CO₂ and CH₄ adsorbed as a function of gas pressure at two different temperatures. The curves were fit with Langmuir adsorption equation (shown on the right of FIG. 5). The parameters a and b are the number of guest sites and the adsorption constant, respectively. The a values are all 1 within experimental error, indicating that a 1:1 guest-host compound is formed. The magnitude of the b values reflect how strongly the gases are adsorbed. The fact that the values for CO₂ are much larger than those for CH₄ means that CO₂ will be adsorbed preferentially from a gas mixture of methane and carbon dioxide, i.e. there is selective adsorption which is a useful property.

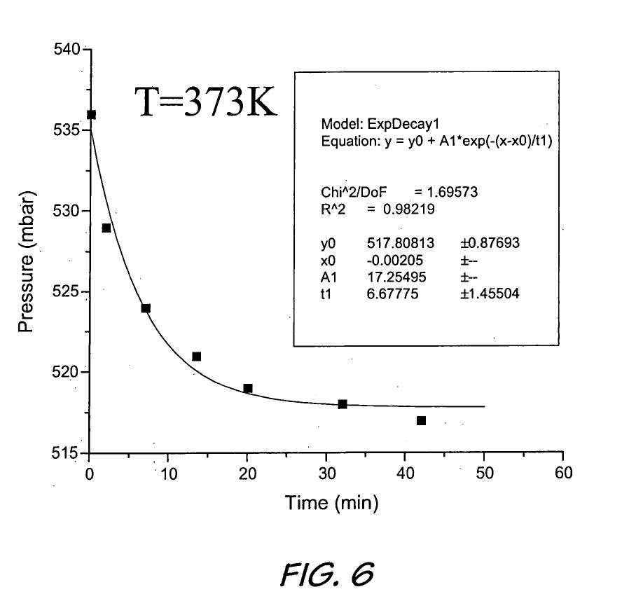

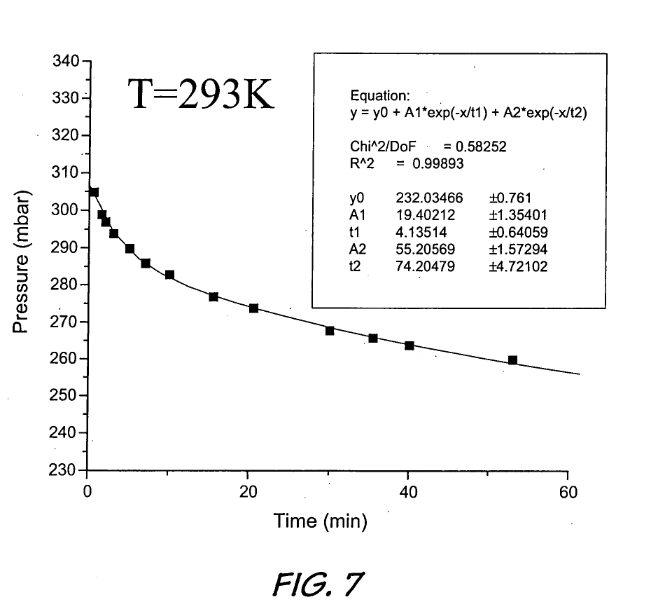

FIGS. 6 and 7 show that for tBC samples of the same particle size, the rate of adsorption of CH₄ depends on temperature with far greater rates being attained at higher temperatures. The decrease in gas pressure over time in FIGS. 6 and 7 is indicative of the rate of adsorption of the methane. The room temperature version of the p-tert-butylcalix[4]arene converts at −90° to another version of the compound, which has not been completely characterized. This polymorph was previously reported (see E. B. Brouwer et at, J. Chem. Commun. 2003, 1416-17). As noted above for the same particle size, the particular polymorph takes up gas much more quickly than the room temperature version of the P2₁/n form of tBC.

Thus, it has been shown that tBC can be used to adsorb a gas such as xenon or carbon dioxide. Because it selectively adsorbs components of a gas mixture, the tBC can be used to separate various gases such as CO₂ from hydrocarbons, e.g. natural gas. The adsorbed gas can be desorbed by heating the tBC/gas combination.

1. A method of adsorbing a gas comprising the step of exposing the gas to the P2₁/n crystal form of p-tert-butylcalix(4)arene or to a form of the p-tert-butylcalix[4]arene derived by heating the p-tert-butylcalix[4]arene to a temperature above the phase transition temperature thereof.

2. The method of claim 1, wherein the gas is selectively adsorbed from a mixture of gases.

3. The method of claim 2, wherein the gas is carbon dioxide, the mixture includes hydrocarbons in admixture with carbon dioxide, and the mixture is exposed to the P2₁/n crystal form of p-tert-butylcalix[4]arene.

4. The method of claim 1, wherein a mixture of carbon dioxide and sulfur dioxide is exposed to the P2₁/n crystal form of p-tert-butylcalix(4)arene to selectively adsorb the carbon dioxide on the p-tert-butylcalix(4)arene.

5. The method of claim 1, wherein a mixture of carbon dioxide and at lease one hydrocarbon is exposed to the P2₁/n crystal form of p-tert-butylcalix(4)arene to selectively adsorb the carbon dioxide on the p-tert-butylcalix(4)arene.

6. The method of claim 5, wherein the hydrocarbon is selected from the group consisting of methane and propane.

7. The method of claim 6, wherein the mixture is left in contact with the p-tert-butylcalix(4)arene for up to one day.

8. The method of claim 6, wherein the mixture and the p-tert-butylcalix(4)arene are heated to promote adsorption.

9. The method of claim 5, wherein the hydrocarbon is methane, and the mixture is heated to a temperature between 273 and 373 K to promote adsorption.
